(19) United States
(12) Patent Application Publication
(10) Pub. No.: US 2025/0013456 A1
(43) Pub. Date: Jan. 9, 2025

(54) METHOD FOR UPDATING AN AUTOMATIC DOOR SYSTEM AS WELL AS AUTOMATIC DOOR SYSTEM

(71) Applicant: Assa Abloy Entrance Systems AB, Landskrona (SE)

(72) Inventor: Marco HAURI, Galgenen (CH)

(21) Appl. No.: 18/710,786

(22) PCT Filed: Nov. 28, 2022
(86) PCT No.: PCT/EP2022/083483

§ 371 Date: May 16, 2024

(30) Foreign Application Priority Data
Dec. 2, 2021 (SE) 2130341-7

(51) Int. Cl. G06F 8/65; E05F 15/73

(52) U.S. Cl. CPC G06F 8/65; E05F 15/73

(57) ABSTRACT

A method for updating an automatic door system (10) is provided, wherein the door system (10) comprises a door (16) with at least one door component (18), a drive unit (20), a control unit (22, 26) for controlling the door system (10) and a sensor connected to the control unit (22, 26). The control unit (22, 26) comprises at least one evaluation module (32). The method comprises the steps of receiving an update package by the control unit (22, 26), and updating the descriptive data of the evaluation module (32) using the information contained in the update package by the control unit (22, 26), wherein the program code of the evaluation module (32) remains unchanged.

The invention concerns a method for updating an automatic door system as well as an automatic door system.

Automatic door systems, for example at buildings, are well known in the art. Today, automatic door systems often comprise a door control unit that drives the drive unit for actuating the actual door leaves. These door control units run a firmware which, just like any other piece of software, needs updates from time to time. Further, door systems are known that comprise a sensor including a camera, wherein the sensors have a control unit separate from the one of the door control unit.

To perform such a firmware update, a downtime is necessary perform a reboot and/or a self-verification of the door regarding its operational safety. During that time the door cannot be used.

It is therefore the object of the invention to provide a method for updating an automatic door system as well as an automatic door system that allows updates to be performed without downtime.

For this purpose, a method for updating an automatic door system is provided, wherein the door system comprises a door with at least one door component, in particular a movable door leaf, at least one drive unit for actuating the at least one door component, a control unit for controlling the door system and at least one sensor connected to the control unit. The control unit comprises at least one evaluation module, being an artificial intelligence evaluation module and/or a machine learning evaluation module, and the evaluation module comprises program code and descriptive data. The method comprises the following steps:
the control unit receives an update package, and
the control unit updates the descriptive data of the evaluation module using the information contained in the update package, wherein the program code of the evaluation module remains unchanged.

By changing only the descriptive data of the evaluation module but not the actual program code, a reboot or verification of the safety of the updated door system is not necessary. Thus, no downtime is needed and the update process is simplified.

The update of the descriptive data may be carried out be overwriting parts of or the entire descriptive data and/or by performing a training of the evaluation module, thus providing different forms of influence on the descriptive data.

In addition or alternatively, the update may be carried out by using an updated instance of parts of or the entire descriptive data for operation while parts of or the entire current descriptive data remains stored. By having two instances of the descriptive data or parts thereof, namely an updated one and a current one, various advantages occur.

For example, the updated instance may be adapted by training of the evaluation module while the door is still operated using the current instance of the descriptive data. The actual update is then the moment that the evaluation module is configured to use the updated instance of the descriptive data for operation. Further, keeping the current descriptive data provides a fallback option in case that unforeseen problems arise with the updated descriptive data.

Within this disclosure, the adjective “current” denotes descriptive data or parts therefore before the update has been taken place.

For example, during operation of the door system, the sensor captures a recording, in particular the sensor being a camera and the recording being a single picture, a series of pictures and/or a video of the field of view of the camera; the evaluation module receives the recording from the sensor and/or an evaluation result; the evaluation module generates an evaluation result by evaluating the recording and/or another evaluation result; and the drive unit is controlled by the control unit based on the evaluation result. This way, the control of the door system is carried out in a precise manner that may be adjusted granularly.

In an embodiment, the evaluation comprises a determination of at least one maintenance parameter of the door system based on the recording and/or an evaluation result, in particular an estimation of the rest of useful life of the door system and/or components of the door system, an estimation of a maintenance need, a determination of a cause for a maintenance need and/or a detection of door anomalies. By determining a maintenance parameter, the maintenance state can be supervised, even remotely.

Door anomalies may be unexpected vibrations, a lack of components, like a missing door profiles or a missing sealing, a loose part or the like.

Further, an estimation may be carried out, whether the maintenance need is caused by a misuse or by a wear out.

In an aspect, the evaluation comprises an analysis of the picture of the recording, in particular object recognition, an estimation of the depth of the scene and/or of an object, a semantical separation of objects, a determination of a region of interest, a detection of fusion of objects and/or persons, a detection of clothing, a detection of carry-on objects, like hand luggage, umbrellas, trollies and/or walking aids, and/or a detection of smoke. The use of automated picture analysis further improves the detection quality of the door system.

In order to further improve the correct opening behavior of the door, the evaluation may comprise the analysis of the situation based on the recording and/or an evaluation result, in particular prediction of a behavior of a person and/or moving objects present in the picture, a prediction of the door usage by an object, a determination of cross traffic, a prediction of a time of arrival of an object at the door, a prediction of the collision probability of objects, a prediction of vandalism, a detection of the wind-load on the door and/or a detection of a mechanical anomaly.

In a further aspect, the evaluation comprises the determination of user centered data based on the recording and/or an evaluation result, in particular counting of persons, identification of persons, authentication of persons, matching persons entering and leaving through the door or another door, tracking of persons, an estimation of a mood of a person, the prediction of the behavior of a person, a detection of the age of a person, an estimation about the abilities of the person, the detection of a presence of a supervisor, and/or an estimation of a crowd. This way, the door system has a functionality going beyond the usual door function of a door system.

In order to perform the best action in any given situation, the evaluation may comprise the determination of an action of the door system based on the recording and/or an evaluation result, in particular a determination of the next movement of the door component, the speed of the door component during the next movement, a determination of a minimal hold-open time, and/or an action to prevent vandalism.

In an embodiment, the sensor is a camera based door safety sensor, in particular the camera monitors the track of the door.

In particular, the camera may be an integral part of the safety functionality of the door and monitors the track of the door. In particular, the camera monitors the track of the door leaf.

For efficient evaluations, the evaluation module may be an adaptive deterministic algorithm, a machine learning algorithm, a support vector machine and/or a trained artificial neural network, in particular configured or trained to generate at least one evaluation result.

The artificial neural network comprises layers and weights that are, in particular, defined by the descriptive data.

In an aspect, the descriptive data comprises information about parameters and/or weights; and/or information about the type of layers, the number and/or types of nodes of the layers, the activation functions of the nodes, the construction of layers, the interconnection of layers, the architecture of the model and/or the design of the evaluation module providing a definition of the evaluations performed by the respective evaluation module separate from the program code.

In addition or in the alternative, the update package comprises training data for the evaluation module, wherein the control unit updates the descriptive data of the evaluation module by performing a training of the evaluation module using the training data so that the experience of the evaluation module is systematically enlarged.

For example, the training data comprises at least one training recording and information about the expected evaluation result based on the respective training recording, in particular wherein the evaluation module is one or more artificial neural networks and for the training the training recording and optionally an evaluation result is fed forward through the one or at least one of the artificial neural networks; an answer evaluation result is determined by the one or at least one of the artificial neural networks based on the training recording; an error between the answer evaluation result of the one or at least one of the artificial neural networks and the expected evaluation result of the one or at least one of the artificial neural networks is determined; and the weights of the one or at least one of the artificial neural networks are changed by back-propagating the error through the respective artificial neural networks.

In an embodiment, the update package comprises updated weights of one or more artificial neural networks of the evaluation module, the layers, the type of layer, the number and/or type of node of the layers, the activation functions of the nodes, and/or interconnections between the layers of one or more artificial neural networks of the evaluation module, an updated model of the evaluation module, an updated architecture of the evaluation module and/or an updated design of the evaluation module, wherein the control unit replaces the current weights, the current layers, the current model, the current architecture and/or the current design of the evaluation module by the updates weights, the updated layers, the updated type of layer, the updated number and/or type of nodes of the layers, the updated activation functions of the nodes, and/or updated interconnections between the layers of the one or more artificial neural networks, the updated model, the updated architecture and/or the updated design, allowing for a very easy and quick update process.

The step of “replacing” of parts of the descriptive may include overwriting respective current data with the updated data or using an updated instance or an updated copy of parts of or the entire descriptive data without deleting the current descriptive data.

In order to allow learning from various sources, the information contained in the update package may be generated by other automatic door systems, by the manufacturer of the door system, by the operator of the door system and/or by a mobile device.

In another embodiment, during operation, the control unit stores usage data, in particular including recordings, in a memory of the control unit; the stored usage data is transmitted to a mobile device or a remote server; the mobile device or the remote server performs an analysis of the usage data and generates an update package based on the usage data received from the control unit; and the update package is transferred to the control unit. By moving the resource-intensive task of analyzing the usage data away from the control unit, the control unit may be equipped with fewer resources.

By collecting a broad range of recordings, the robustness, accuracy and effectiveness of the models, architectures, weights can be drastically improved resulting in safer and more accurate, building-energy optimized door functions.

The usage data may include recordings, actions of the door system taken in response to the recording, information about the influence of the action on the situation, and/or information about the correct evaluation result.

In an embodiment, before updating the descriptive data, the control unit stores usage data of the past in a memory of the control unit; and after the update has been performed, the control unit uses the stored usage data to adapted the descriptive data, in particular to perform a training of the evaluation module using the stored usage data. By storing usage data of the past, the experience of the individual door system is saved and can be built upon even after the descriptive data has been altered extensively during the update.

In order to avoid misuse and errors, prior to updating the evaluation module, the control unit may verify the received update package with respect to its authenticity, completeness, integrity and/or correctness, in particular cryptographically.

In an aspect, the control unit receives the update package via a wireless or wired connection, in particular from a remote sever, from a mobile device in the vicinity of the door system and/or another automatic door system, allowing for a flexible distribution of the update package.

For above mentioned purpose, an automatic door system is further provided. The automatic door system comprises at least one door component, in particular a movable door leaf, at least one drive unit for actuating the at least one door component, a control unit for controlling the door system, and at least one sensor connected to the control unit, wherein the door system is configured to carry out the method as described above, in particular wherein the sensor comprises a camera and/or the sensor is a door safety sensor.

The features and advantages mentioned with respect to the method also apply to the automatic door system and vice versa.

Further features and advantages will be apparent from the following description as well as the accompanying drawings, to which reference is made. In the drawings:

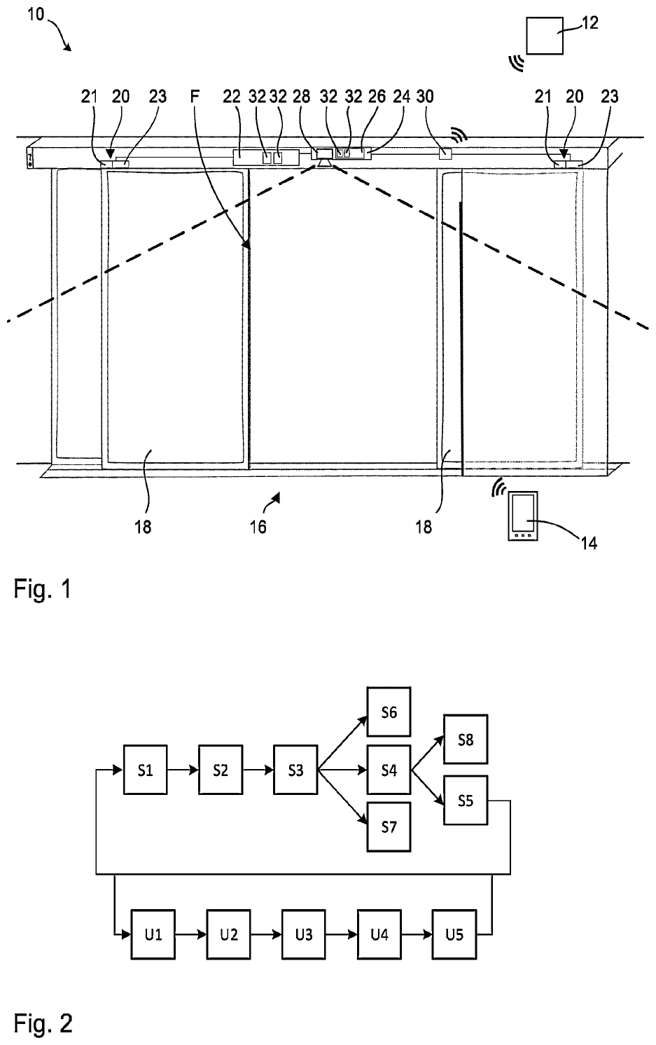

FIG. 1: shows schematically an automatic door system according to the invention, and

FIG. 2: shows a flowchart of a method according to the invention.

FIG. 1 shows schematically an automatic door system 10 according to the invention, a remote server 12 and a mobile device 14.

The automatic door system 10 has a door 16 with at least one door component 18, a drive unit 20, a door control unit 22 and a safety sensor 24.

In the shown embodiment, the door 16 is a sliding door with two independent door components 18 being movable door leaves. Thus, also two drive units 20 are provided.

The door 16 may as well be a swing door, a revolving door, a folding door or the like. The method of operation remains the same.

The safety sensor 24 and the drive unit 20 are connected to the door control unit 22, wherein the door control unit 22 is configured to control the drive unit 20.

Each of the drive units 20 comprise an actuator 21, like an electric motor, and power electronics 23 for the actuator 21.

Each of the drive units 20 is associated with one of the door components 18 and is designed to move the respective door component 18 along a track. The door components 18 may be moved individually from one another.

In particular, the door components 18 are movable such that between them a passage can be opened, wherein the width of the passage is adjustable by the door control unit 22.

The door control unit 22 is, for example, an embedded system running a firmware.

The safety sensor 24 comprises a safety control unit 26 and a camera 28 as the sensor.

The door system 10 may comprise further sensors, like a distance sensor, for various purposes, like detecting objects or persons in front of the door 16.

The camera 28 is located above the door 16 and monitors the track of the door 16, i.e. the movement path of the door components 18.

The camera 28 may be a single camera, a stereo camera, a time-of-flight 3D camera, an event camera or a plurality of cameras.

The field of view F of the camera 28 includes the track of the door 16, in particular the track of the door leaves, and a safety zone in front of the door leaves. The safety zone may extend at least 20 cm in front of the door leaves.

The field of view F of the camera 28 may cover an area of up to 5 m, preferably up to 7 m, more preferably still up to 10 m in front of the door 16, measured on the ground.

The safety sensor 24 is an integral part of the safety functionality and/or the door usage detection functionality of the door system 10. Mainly, the camera 28 monitors the track of the door 16, i.e. the movement path of the door leaves, and forwards the recording to the safety control unit 26. The safety control unit 26 instructs the door control unit 22 to ensure that the door 16 is operated safely. In particular, to ensure that persons, for example vulnerable persons such as children or elderly people, present in the track of the door 16 are not touched or even harmed by a movement of the door component 18.

Further, the safety sensor 24 is configured to detect persons wishing to pass the door 16.

The camera 28 captures at least one recording, for example a single picture, a series of pictures and/or a video, of the field of view F and transmits the recording to the safety control unit 26.

The safety control unit 26 evaluates the captured recording and, based on the recording, sends instructions to the door control unit 22 to operate the door 16 accordingly.

For example, for the door usage detection functionality, the safety control unit 26 determines whether or not persons are present in the field of view F of the camera 28, i.e. in the recording, and whether or not a person desires to pass the door 16. If so, the safety control unit 26 instructs the door control unit 22 to open the door 16.

Then the door control unit 22 instructs the drive units 20 to create the desired motion of the respective door component 18 to open the door.

The safety control unit 26 may also be an embedded system running a firmware.

It is to be noted that the safety control unit 26 and the door control unit 22 are separate control units with different purposes and running different firmware.

The safety control unit 26 and/or the door control unit 22 is connected to the remote server 12 and/or to the mobile device 14.

For example, the automatic door system 10 comprises a connectivity module 30, like a wireless communication module or an Ethernet module, wherein the connectivity module 30 is connected to the safety control unit 26 and/or the door control unit 22.

The connection between the connectivity module 30, the safety control unit 26 and/or the door control unit 22 may be realized by a bus of the automatic door system 10. Further, the drive units 20 and/or sensors may be connected to the bus.

The connectivity module 30 may be part of the safety sensor 24, the safety control unit 26 and/or the door control unit 22.

It is also conceivable that the safety control unit 26 is part of the door control unit 22.

The remote server 12 is, for example, a server connected to the internet located at a remote location from the automatic door system 10.

It is also conceivable, that the remote server 12 is located on the same premise as the automatic door system 10.

The connection of the safety control unit 26 and/or the door control unit 22 to the remote server 12 may be a wired connection or a wireless connection in the sense that the safety control unit 26 has established a wireless connection to a gateway in the vicinity of the automatic door system 10, which is in turn connected, for example via the Internet, to the remote server 12.

The safety control unit 26 and/or the door control unit 22 may comprise an evaluation module 32. The evaluation module 32 may comprise a machine learning module having an adaptive deterministic algorithm, a machine learning algorithm and/or a support vector machine. In addition or in the alternative, the evaluation module 32 may be a machine learning module having a trained artificial neural network.

The movement of the door component 18 is controlled by the door control unit 22, which instructs the drive unit 20 accordingly.

The decision to move the door component 18, e.g. to open or close the door, is, for example, made by the door control unit 22. To do so, the door control unit 22 receives information from the safety sensor 24 or other sensors. The evaluation module 32 of the door control unit 22 receives this information and determines the action of the door system 10 based on this information.

As illustrated in FIG. 2, during operation, the sensor—in the shown embodiment the camera 28—captures a recording and transmits this recording to the safety control unit 26 (step S1).

The evaluation module 32 of the safety control unit 26 receives the recording and generates an evaluation result based on the recording, i.e. by evaluating the recording (step S2).

For example, during the evaluation, the picture of the recording is analyzed, therefore the evaluation module 32 may recognize objects in the picture, may estimate the depth of the scene and/or of the recognized object, may perform a semantical separation of objects, may determine a region of interest, may detect fusion of objects or persons that have been separate entities beforehand, may detect the type of clothing worn by a person, may detect carry-on objects, like hand luggage, umbrellas, trolleys and/or walking aids that are carried by persons and/or may detect smoke.

The results of the evaluation, e.g. information on recognized objects, the region of interest, etc., are called evaluation results in the following and may be used by the same or other evaluation module 32 as input.

Then, the evaluation module 32 of the safety control unit 26 analyzes the current situation in front of the door based on the recording and also on the evaluation result of the analysis of the picture that has been performed before.

For example, the evaluation module 32 then predicts the behavior of a person and/or of a moving object present in the picture predicts, the door usage by an object, determines the cross traffic, predicts the time of arrival of an object at the door, predicts the collision probability of the object, predicts vandalism, detects the wind load on the door and/or detects a mechanical anomaly.

The analysis of the situation may be performed by the same evaluation module 32 or another evaluation module 32 separate from the evaluation module carrying out the analysis of the picture.

The evaluation results of the evaluation module 32 of the safety control unit 26 are transmitted to the evaluation module 32 of the door control unit 22 (step S3).

The evaluation module of the door control unit 22 receives the evaluation results. In addition or in the alternative, the evaluation module 32 receives the recording captured by the sensor.

In step S4, the evaluation module 32 of the door control unit 22 determines an action of the door system 10 based on the recording and/or the evaluation results received from the safety control unit 26.

For example, the evaluation module 32 determines the action, e.g. the next movement of the door component 18, the speed of the door component 18 during the next movement, a minimal hold-open time and/or an action to prevent vandalism.

In particular, if the evaluation result of the evaluation module 32 of the safety control unit 26 indicates that a person approaches the door 16 with a given speed, the evaluation module 32 of the door control unit 22 determines that the door 16 has to be opened as well as the speed with which the door components 18 have to be moved. Then, the door control unit 22 instructs the drive units 20 accordingly.

In step S5, the door control unit 22 instructs the drive unit 20 to actuate the door component 18 according to the action that has been determined by the evaluation module 32 beforehand.

Further, the evaluation module 32 of the door control unit 22 or the safety control unit 26 may determine user centered data based on the recording or on the evaluation results of the evaluation module 32 of the safety control unit 26 (step S6).

For example, persons are counted that have passed the door 16, persons are identified and/or their authorization is checked, persons entering and leaving through the door 16 or another door system connected to the door system 10 are matched to improve the accuracy of the count of persons, persons are tracked, the mood of a person is estimated, the behavior of the person is predicted and/or the age of a person is detected. Further, the evaluation module 32 may estimate the abilities of a person, for example whether or not the person will be able to reach the door 16 in a specific time. Further, the presence of a supervisor may be detected or a crowd may be estimated.

In addition or in the alternative, the evaluation module 32 may determine a maintenance parameter of the door system 10 based on the recording or on evaluations results of the evaluation module 32 of the safety control unit 26 (Step S7).

For example, the evaluation module 32 may estimate the rest of useful life of the door system 10 and/or of components of the door system 10.

Further, a maintenance need may be estimated and a cause for a maintenance need may be determined. For example, it may be estimated if the maintenance need is due to misuse, vandalism or normal wear.

Furthermore, the presence of anomalies of the door 16 may be detected, for example unexpected vibrations, a lack of a component, like a missing door profile or sealing, or loose parts of the door 16.

The evaluations mentioned are either performed by the same evaluation module 32 or multiple evaluation modules 32. For example, a separate and specialized evaluation module 32 is provided in the door control unit 22 or the safety control unit 26, respectively, for each evaluation.

To this end, the evaluation modules 32 comprise program code and descriptive data. The program code determines how the evaluation module 32 is executed whereas the descriptive data comprises the parameters and/or weights. In addition or in the alternative to the parameters or weights, the descriptive data may include information about the architecture of the model, e.g. the number of layers, the type of layer, the number of nodes in the layers, their further construction and interconnections between the layers and/or the design of the evaluation module 32.

In case of an artificial neural network as an evaluation module 32, the descriptive data defines the weights of the connections between nodes, information about the layers (number of layers, type or kind of layers, number of nodes in a layer, the activation functions of the nodes), the connections of the layers and nodes and the like.

Further, during the operation, i.e. during steps S2 to S7, the safety control unit 26 and/or the door control unit 22 may store usage data in a memory of the respective control unit 22, 26 (Steps S8).

The usage data may be recordings, actions of the door 16 taken in response to the recording (like instructions to the drive units 20), information about the influence of the action on the situation, and/or information about the correct evaluation result.

The influence of the action on the situation may be determined by evaluating a recording at a later point in time after the action has been taken by the door system 10, in particular after the door component 18 has been moved.

Likewise, information about the correct evaluation results may be provided by evaluating recordings that are taken at a later point in time after the recording that has led to the respective evaluation result.

By a repetition of steps S1 to S8, in particular with the frame rate of the camera 28, the door system 10 is operated safely.

In order to provide the necessary evaluations, the one evaluation module 32 or the plurality of the evaluation modules 32 of the safety control unit 26 or the door control unit 22, respectively, are configured and/or trained to perform and support the tasks of the respective control unit 22, 26. For example, the evaluation module 32 of the safety control unit 26 is configured and/or trained to recognize persons in the recording that desire to pass the door 16.

For updating the automatic door system 10, the following steps are performed that are also illustrated in FIG. 2.

For ease of understanding, it is referred to the control unit 22, 26 in the following which may refer to the door control unit 22, the safety control unit 26 or, in other embodiments, any other control unit of the door system 10.

In step U1, the control unit 22, 26 receives at least one update package from the remote server 12 or from a connected mobile device 14. The transmission of the update package may be initiated by the control unit 22, 26, the remote server 12 or the mobile device 14. The update package may be received wirelessly or by a wired connection.

On the remote server 12, update packages are stored.

The mobile device 14 may be a laptop, a tablet, a smart phone or any other smart device. The mobile device 14 may belong to a service technician, a janitor, a superintendent of the building the door system 10 is installed in or any other person authorized to initiate an update of the door system 10.

For transmission, the mobile device 14 is brought into the vicinity of the automatic door system 10 and is connected to the safety control unit 26 either wirelessly, for example using Wi-Fi, Bluetooth, Ultra-wideband, or the like, or via a cable.

Just like the remote server 12 the mobile device 14 has update packages stored within or may establish a communication connection to a server having update packages stored. As the mobile device 14 will be carried away by the owner afterwards, the mobile device 14 is connected to the safety control unit 26 only temporarily.

It is also conceivable, that the control unit 22, 26 may receive update packages from another automatic door system connected to the door system 10, for example using a field bus and/or a LAN in the same building or an internet connection.

The update package comprises updated weights of the evaluation module 32 to be updated, updated layers of the evaluation module 32, an updated model of the evaluation module, an updated architecture of the evaluation module 32 and/or an updated design of the evaluation module 32. Thus, the update package comprises parts of or the entire descriptive data of the evaluation module 32 to be updated.

In addition or in the alternative, the update package may comprise training data for the evaluation module 32 to be updated. This may be particularly used in case of an artificial neural network used as the evaluation module 32.

Further, the update package may comprise training instruction. If the control unit carries 22, 26 out a training of the evaluation module 32 according to the training instructions, the descriptive data is updated accordingly.

For example, the training instructions include the instructions to take the recording of ten occurrences of a male person, age between 25 and 35 without disabilities, that has approached and passed the door 16 and evaluate the recording in terms of the velocity with which the person has approached the door. The mean velocity value may then be stored (in form of weights or as a parameter) as part of the descriptive data as a reference value.

Thus, the reference value will be an individual value depending on the local environment at the door. In above example, if a step or a slope is present in front of the door 16, the velocity will be smaller than for doors without a step or slope present.

In particular, the update package does not include program code of the evaluation module 32.

In step U2, the control unit 22, 26 verifies the received updated packages with respect to the authenticity, the completeness, the integrity and/or correctness. This verification may be done cryptographically, for example using hashes and/or digital signatures, as known in the art.

In optional step U3, before changing, i.e. updating the respective evaluation module 32, the control unit 22, 26 stores usage data of the past, for example usage data that has been recorded during operation in step S8. The usage data may be store in a memory of the control unit 22, 26 in the manner that the update of the evaluation module 32 does not alter the usage data of the past.

In step U4, the control unit 22, 26 carries out the update of the respective evaluation module 32 by amending only the descriptive data of the evaluation module 32 but leaving the program code of the evaluation module 32 unchanged.

For example, the control unit 22, 26 changes the model, architecture and/or design of the evaluation module 32 to be updated according to the model, architecture and/or design given in the update package.

In case of an artificial neural network as an evaluation module 32, the control unit 22, 26 may replace the current weights and/or the current layers and/or the current architecture of the neural network module by using the information in the update package, e.g. the updated weights, the updated layers and the updated architecture given in the update package.

During this step, the current parts of the descriptive data or the entire descriptive data may be overwritten with the updated parts of or the entire updated descriptive data. Alternatively, an updated instance of the descriptive data is generated, e.g. by creating a copy of the current descriptive data and changing either the copy or the original to obtain the updated descriptive data.

This way, in cases that unforeseen problems with the updated descriptive data occur, the stored current (unupdated) descriptive data can be used again as a fallback option.

It is also possible to use the current and the updated descriptive data in parallel, e.g. the door 16 is operated based on the current descriptive data but trainings of the updated descriptive data are performed until the updated descriptive data is used for actual operation of the door system 10.

An additional or in the alternative, if the update package comprises training data and/or training instructions, the control unit 22, 26 changes the descriptive data of the evaluation module 32 by performing a training of the evaluation module 32 using the training data and/or by following the instructions of the update package, e.g. collecting specific data to perform a training as described above.

For example, if the evaluation module 32 to be updated is an artificial neural network, firstly, the training recording and optionally an evaluation result is fed forward through the artificial neural network. Then, an answer evaluation result by the artificial neural network based on the training recording is determined, and an error between the answer evaluation result of the artificial neural network and the expected evaluation result of the artificial neural network is determined. Then the weights of the artificial neural network are changed by back-propagating the error through the artificial neural network.

To this end, the training data comprises at least one training recording and associated information about the expected evaluation result based on the respective training recording. For example, the training recording is a picture of the situation in front of the door 16 and the expected evaluation result contains the objects to be recognized by the evaluation module 32 in the picture.

Then, in U5, if usage data of the past has been stored beforehand, the control unit 22, 26 may use the stored usage data to adapt the descriptive data of the updated evaluation module 32 to make use of experiences in the past.

In particular, the usage data of the past is used to perform a training of the respective evaluation module 32 in a manner as explained before with respect to the training using the training data.

This way, the learnings from the past experience of the door system 10, in particular such learning that are specific to the very location the door system 10 is installed in, are not lost but can be carried over even after an update of the respective evaluation module 32 has been performed.

In case of an updated instance of the descriptive data, as described before, step U5 may be performed on the updated instance of the descriptive data while the door 16 is operated based on the current instance of the descriptive data. When the trainings are complete, the updated instance of the descriptive data is used for the operation of the door 16, i.e. constituting the update of step U4.

Then, the update of the evaluation module 32 and thus the door system 10 has been completed successfully without the need to change any program code that would necessitate a reboot or downtime of the door system 10.

Further, the update packages, more precisely the information contained in the update packages may not only be provided by the manufacturer of the door system 10 but also by other parties that may provide benefits to other door systems 10.

The operator of the automatic door system 10 may also determine the information contained in the update package, e.g. by configuring rules that define certain behaviors in reaction to certain situations.

For example, the operator of a door system 10, for example a shop owner, may desire that dogs do not enter his shop and thus generates—using a user-friendly terminal and/or a dedicated app on his/her mobile device—an update package that conveys this particular rule to the automatic door system 10.

Further, the automatic door systems 10 may provide information contained in an update package. For example, the usage data of the past of one door system 10 may be used to create an update package that is distributed to other door systems 10. This way, door systems 10 may learn from one another.

It is also possible, that the information contained in the update package originates from the very same door system 10 that is updated. For example, the control unit 22, 26 may store usage data during operation, in particular recordings, in the memory of the control unit (cf. step 8).

In particular, the recordings of the usage data are such that a situation and the change of the situation in response to an action of the door system are visible.

Further, in the usage data information about actions that the door system has taken are stored, in particular information about the movement of the door component 18 in reaction to a recording.

In the next step, the stored usage data may then be transmitted to the mobile device 14 or the remote server 12.

On the mobile device 14 or on the remote server 12, and analysis of the usage data is performed. During the analysis, the reactions of the door system 10 in various situations are analyzed and it is evaluated whether a better reaction would have been possible. Based on this evaluation, a respective update package is generated by the mobile device 14 or the remote server 12.

This way, it is not necessary to equip the control unit 22, 26 with the resources needed to learn from past events on its own. Instead, this resource consuming task is outsourced to the mobile device 14 and/or the remote server 12 which are equipped with such resources more easily.

This way, a door system 10 is provided which can easily be updated without any downtime and even may receive information, and thus learn from various sources.

1. Method for updating an automatic door system (10), wherein the door system (10) comprises a door (16) with at least one door component (18), in particular a movable door leaf, at least one drive unit (20) for actuating the at least one door component (18), a control unit (22, 26) for controlling the door system (10) and at least one sensor connected to the control unit (22, 26),
wherein the control unit (22, 26) comprises at least one evaluation module (32), being an artificial intelligence evaluation module and/or a machine learning evaluation module, the evaluation module (32) comprising program code and descriptive data, wherein the method comprises the following steps:
the control unit (22, 26) receives an update package, and
the control unit (22, 26) updates the descriptive data of the evaluation module (32) using the information contained in the update package, wherein the program code of the evaluation module (32) remains unchanged.

2. Method according to claim 1, characterized in that the update of the descriptive data is carried out be overwriting parts of or the entire descriptive data; by using an updated instance of parts of or of the entire descriptive data for operation while parts of or the entire current descriptive data remains stored; and/or by performing a training of the evaluation module (32).

3. Method according to claim 1, characterized by the following steps:
the evaluation module (32) receives an evaluation result and/or a recording from the sensor, the recording being captured by the sensor during operation of the door system (10), in particular the sensor being a camera (28) and the recording being a single picture, a series of pictures and/or a video of the field of view (F) of the camera (28),
the evaluation module (32) generates an evaluation result by evaluating the recording and/or another evaluation result making use of the updated descriptive data, and
the drive unit (20) is controlled by the control unit (22, 26) based on the evaluation result.

4. Method according to claim 3, characterized in that the evaluating comprises a determination of at least one maintenance parameter of the door system (10) based on the recording and/or an evaluation result, in particular an estimation of the rest of useful life of the door system (10) and/or components of the door system (10), an estimation of a maintenance need, a determination of a cause for a maintenance need and/or a detection of door anomalies.

5. Method according to claim 3, characterized in that the evaluating comprises an analysis of the picture of the recording, in particular object recognition, an estimation of the depth of the scene and/or of an object, a semantical separation of objects, a determination of a region of interest, a detection of fusion of objects and/or persons, a detection of clothing, a detection of carry-on objects, like hand luggage, umbrellas, trollies and/or walking aids, and/or a detection of smoke.

6. Method according to claim 3, characterized in that the evaluating comprises the analysis of the situation based on the recording and/or an evaluation result, in particular prediction of a behavior of a person and/or moving objects present in the picture, a prediction of the door usage by an object, a determination of cross traffic, a prediction of a time of arrival of an object at the door (16), a prediction of the collision probability of objects, a prediction of vandalism, a detection of the wind-load on the door (16) and/or a detection of a mechanical anomaly.

7. Method according to claim 3, characterized in that the evaluating comprises the determination of user centered data based on the recording and/or an evaluation result, in particular counting of persons, identification of persons, authentication of persons, matching persons entering and leaving through the door (16) or another door, tracking of persons, an estimation of a mood of a person, a detection of the age of a person, an estimation about the abilities of the person, the detection of a presence of a supervisor, and/or an estimation of a crowd.

8. Method according to claim 3, characterized in that the evaluating comprises the determination of an action of the door system (10) based on the recording and/or an evaluation result, in particular a determination of the next movement of the door component (18), the speed of the door component (18) during the next movement, a determination of a minimal holdopen time, and/or an action to prevent vandalism.

9. Method according to claim 3, characterized in that the sensor is a camera of a camera based door safety and/or door usage sensor (24), in particular the camera (28) monitors the track of the door (16).

10. Method according to claim 1, characterized in that the evaluation module (32) is an adaptive deterministic algorithm, a machine learning algorithm, a support vector machine and/or a trained artificial neural network, in particular configured or trained to generate at least one evaluation result.

11. Method according to claim 1, characterized in that the descriptive data comprises information about parameters and/or weights; and/or information about the type of layers, the number and/or types of nodes of the layers, the activation functions of the nodes, the construction of layers, the interconnection of layers, the architecture of the model and/or the design of the evaluation module (32).

12. Method according to claim 1, characterized in that the update package comprises training data for the evaluation module (32) and/or training instructions, wherein the control unit (22, 26) updates the descriptive data of the evaluation module (32) by performing a training of the evaluation module (32) using the training data and/or by carrying out the training instructions.

13. Method according to claim 12, characterized in that the training data comprises at least one training recording and information about the expected evaluation result based on the respective training recording, in particular wherein the evaluation module is one or more artificial neural networks and the training comprises the following training steps:
feed forward of the training recording and optionally an evaluation result through the one or at least one of the artificial neural networks;
determining an answer evaluation result by the one or at least one of the artificial neural networks based on the training recording,
determining an error between the answer evaluation result of the one or at least one of the artificial neural networks and the expected evaluation result of the one or at least one of the artificial neural networks; and
changing the weights of the one or at least one of the artificial neural networks by back-propagating the error through the one or at least one of the artificial neural network.

14. Method according to claim 1, characterized in that the update package comprises updated weights of one or more artificial neural networks of the evaluation module (32), the layers, the type of layer, the number and/or type of node of the layers, the activation functions of the nodes, and/or interconnections between the layers of one or more artificial neural networks of the evaluation module (32), an updated model of the evaluation module (32), an updated architecture of the evaluation module (32) and/or an updated design of the evaluation module (32), wherein the control unit (22, 26) replaces the current weights, the current layers, the current model, the current architecture and/or the current design of the evaluation module (32) by the updates weights, the updated layers, the updated type of layer, the updated number and/or type of node of the layers, the updated activation functions of the nodes, and/or updated interconnections between the layers of the one or more artificial neural networks, the updated model, the updated architecture and/or the updated design.

15. Method according to claim 1, characterized in that the information contained in the update package is generated by another automatic door system, by the manufacturer of the door system (10), by the operator of the door system (10) and/or by a mobile device (14).

16. Method according to claim 15, characterized in that the method comprises the further following steps:
during operation, the control unit (22, 26) stores usage data, in particular including recordings, in a memory of the control unit (22,26),
the stored usage data is transmitted to a mobile device (14) or a remote server (12),
the mobile device (14) or the remote server (12) performs an analysis of the usage data and generates an update package based on the usage data received from the control unit (22, 26), and
the update package is transferred to the control unit (22, 26).

17. Method according to claim 1, characterized in that the method comprises the further following steps:
the control unit (22, 26) stores usage data of the past in a memory of the control unit (22, 26), in particular before updating the descriptive data, and
the control unit (22, 26) uses the stored usage data to adapted the descriptive data, in particular to perform a training of the evaluation module (32) using the stored usage data, wherein particularly an updated instance of the descriptive data is adapted or the descriptive data is adapted after the update has been performed.

18. Method according to claim 1, characterized in that, prior to updating the evaluation module (32), the control unit (22, 26) verifies the received update package with respect to its authenticity, completeness, integrity and/or correctness, in particular cryptographically.

19. Method according to claim 1, characterized in that the control unit (22, 26) receives the update package via a wireless or wired connection, in particular from a remote sever (12), from a mobile device (14) in the vicinity of the door system (10) and/or another automatic door system.

20. Automatic door system comprising at least one door component (18), in particular a movable door leaf, at least one drive unit (20) for actuating the at least one door component (18), a control unit (22, 26) for controlling the door system (10), and at least one sensor connected to the control unit (22, 26), wherein the door system (10) is configured to carry out the method according to claim 1, in particular wherein the sensor comprises a camera (28) and/or the sensor is a door safety and/or door usage sensor (24).
